(19) United States
(12) Patent Application Publication
(10) Pub. No.: US 2017/0024774 A1
(43) Pub. Date: Jan. 26, 2017

(54) METHOD AND SYSTEM OF AUTOMATED ONLINE CUSTOM BRAND-INTEGRATION PRICING

(71) Applicants: Chadwick Michael SAHLEY, Los Angeles, CA (US); Samuel Austin MICHIE, Los Angeles, CA (US)

(72) Inventors: Chadwick Michael SAHLEY, Los Angeles, CA (US); Samuel Austin MICHIE, Los Angeles, CA (US)

(21) Appl. No.: 15/084,477

(22) Filed: Mar. 30, 2016

Related U.S. Application Data
(60) Provisional application No. 62/139,878, filed on Mar. 30, 2015.
(60) Provisional application No. 62/211,984, filed on Aug. 31, 2015.
(60) Provisional application No. 62/263,731, filed on Dec. 6, 2015.

(51) Int. Cl. G06Q 30/02

(52) U.S. Cl. CPC G06Q 30/0273; G06Q 30/0277

(57) ABSTRACT

In one aspect, a computerized method useful for implementing automated custom brand-integration pricing and useful for improving online digital advertisements including the step of obtaining an online content provider's information. An online content provider comprises a user of an online media-content sharing website that uploads media content available on said online media-content sharing website. The online content provider's information includes a popularity indicator of the user's media content on said online media-content sharing website. The method includes the step of calculating an engagement statistic, wherein the engagement statistic is a function of the online content provider's information. The method includes the step of determining a content provider's pricing rate for a custom brand-integration into the online media-content of said user The content provider's pricing rate is a function of the engagement statistic.

### CROSS-REFERENCE TO RELATED APPLICATIONS

This application is a claims priority from provisional U.S. Application Provisional No. 62/139,878 filed 30-Mar.-2015. This application is hereby incorporated by reference in its entirety. This application is a claims priority from provisional U.S. Application Provisional No. 62/211,984 filed 31-Aug.-2015. This application is hereby incorporated by reference in its entirety. This application is a claims priority from provisional U.S. Application Provisional No. 62/263,731 filed 6-Dec.-2015. This application is hereby incorporated by reference in its entirety.

### FIELD OF THE INVENTION

This application relates generally to online marketing, and more specifically to a system, article of manufacture and method of automated custom brand-integration pricing.

### DESCRIPTION OF THE RELATED ART

Media-content providers can upload media content (e.g. digital videos digital images, digital song files, etc.) to websites. For example, a user can upload a set of videos to YouTube®. Another user can upload pictures to Instagram®. These users can become popular with viewers. For example, a user's video can be watched by millions of people. Another user can have hundreds of thousands of followers on Instagram®. Accordingly, the users may wish to monetize their uploaded media content. One method of monetization of media content is brand integration. However, the users may not know the value of their media content in terms of brand integration. Moreover, users may not want to personally negotiate brand integration values with a host of potential advertisers. Therefore, improvements to current methods that use automated custom brand-integration pricing are provided herein.

### BRIEF SUMMARY OF THE INVENTION

In one aspect, a computerized method useful for implementing automated custom brand-integration pricing and useful for improving online digital advertisements including the step of obtaining an online content provider's information. An online content provider comprises a user of an online media-content sharing website that uploads media content available on said online media-content sharing website. The online content provider's information includes a popularity indicator of the user's media content on said online media-content sharing website. The method includes the step of calculating an engagement statistic, wherein the engagement statistic is a function of the online content provider's information. The method includes the step of determining a content provider's pricing rate for a custom brand-integration into the online media-content of said user. The content provider's pricing rate is a function of the engagement statistic.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process 100 content provider appraisal, according to some embodiments,

FIG. 2 illustrates an example process for custom brand-integration pricing, according to some embodiments.

FIGS. 3A-H illustrate example indices for implementing process for custom brand-integration pricing, according to some embodiments.

FIG. 4 illustrates an example process for implementing automated custom brand integration pricing, according to some embodiments.

FIGS. 5 and 6 illustrates example processes that can be utilized to automatically form marketing/advertisement contracts between content providers, sponsors and/or content servers, according to some embodiments.

FIG. 7 is a block diagram of a sample-computing environment that can be utilized to implement some embodiments.

FIG. 8 depicts an exemplary computing system that can be configured to perform any one of the processes provided herein.

The Figures described above are a representative set, and are not an exhaustive with respect o embodying the invention.

### DETAILED DESCRIPTION

Disclosed are a system, method, and article of manufacture of online marketing. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment” “an embodiment,” one example,' or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance an arrow may indicate a waiting or monitoring period of unspecified duration between enumerated steps of the depicted method. Additionally, the order in which a particular method occurs may or may not strictly adhere to the order of the corresponding steps shown.

Definitions

The following are example definitions that can be utilized to implement some embodiments.

API (application program interface) is a set of routines, protocols, and tools. The API specifies how software components should interact. An API can include a language and message format used by an application program to communicate with the operating system or some other control program such as a database management system (DBMS) or communications protocol.

Backtesting can refer to testing a predictive model using existing historic data. Backtesting is a kind of retrodiction, and a special type of cross-validation applied to time series data.

Behavioral analytics is a subset of business analytics that focuses on how and why a user of a specified application behaves.

Bootstrap aggregating (‘bagging’) can be a machine learning ensemble meta-algorithm designed to improve the stability and accuracy of machine learning algorithms used in statistical classification and regression.

Cluster analysis or clustering is the task of grouping a set of objects in such a way that objects in the same group (called a cluster) are more similar (in some sense or another) to each other than to those in other groups (clusters).

Data aggregator can be an organization involved in compiling information from detailed databases on individuals and providing that information to others.

Database management system (DBMS) can be a computer program (or more typically, a suite of them) designed to manage a database, a large set of structured data, and run operations on the data requested by numerous users, processes, etc.

Ensemble learning can use multiple learning algorithms to obtain better predictive performance than could be obtained from any of the constituent learning algorithms

Event rate a measure of how often a particular statistical event (such as those discussed infra) occurs within the experimental group (such as those discussed infra) of an experiment.

Fuzzy clustering is a class of algorithms for cluster analysis in which the allocation of data points to clusters is not “hard” (all-or-nothing) but “fuzzy” in the same sense as fuzzy logic.

Customer relationship management (CRM) can be a system for managing a company's interactions with current and future customers It often involves using technology to organize, automate and synchronize sales, marketing, customer service, and technical support.

Logistic regression can include, inter alia, measuring the relationship between the categorical dependent variable and one or more independent variables, which are usually (but not necessarily) continuous, by using probability scores as the predicted values of the dependent variable.

Mean squared error (MSE) of an estimator can measure the average of the squares of the “errors”, that is, the difference between the estimator and what is estimated.

Random forest can be an ensemble learning method for classification, regression and other tasks, that operate by constructing a multitude of decision trees at training time and outputting the class that is the mode of the classes (e.g. classification) or mean prediction (e.g. regression) of the individual trees. Random forests can correct for decision trees' habit of overfitting to their training set. As an ensemble method, random Forest can combine one or more ‘weak’ machine-learning methods together. Random forest can be used in supervised learning (e.g. classification and regression), as well as unsupervised learning (e.g. clustering).

Request for proposal (RfP) can be a solicitation (e.g. as part of a bidding process) by an agency or company interested in procurement of a commodity, service or valuable asset, to potential suppliers to submit business proposals. In one example, a content provider (e.g. can include a content creator, etc.) can send an RfP to one or more media servers and/or sponsors. An RfP can be included in an offer

Test data set can be a set of data used in various areas of information science to assess the strength and utility of a predictive relationship.

Training set can be a set of data used in various areas of information science to discover potentially predictive relationships. Training sets can be used in artificial intelligence, machine learning, genetic programming, intelligent systems, and statistics.

Exemplary Methods

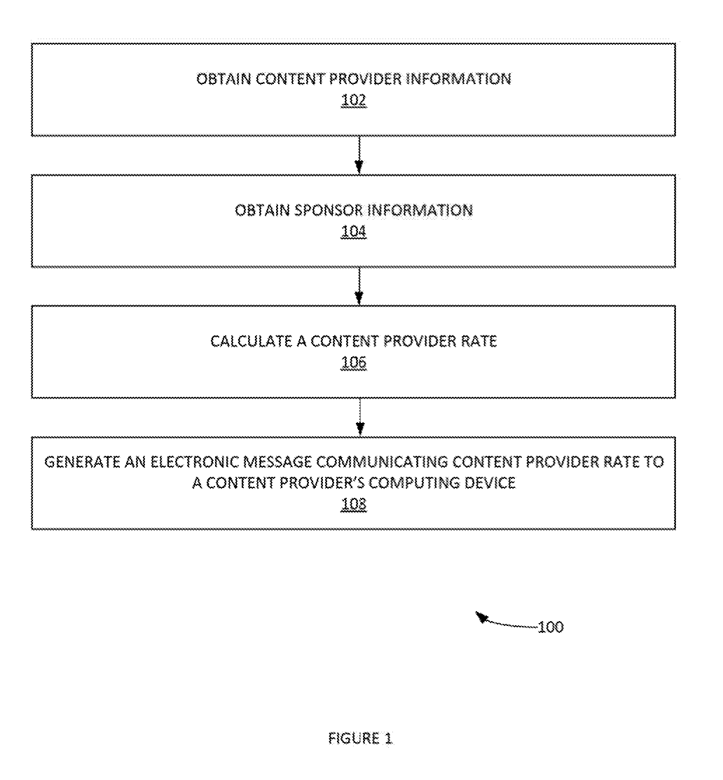

FIG. 1 illustrates an example process 100 for content provider appraisal, according to some embodiments. In step 102 of process 100, a content provider's information can be obtained. As used herein, a content provider (e.g. can include a content creator, etc.) can be a person that provides digital content (e,g, media content, microblog posts, blog posts, etc.) to an entity, such as a content server (e.g. YouTube®. Twitter®, Facebook®, Pinterest®, Instagram®, Vine®, Snapchat®. Twitch®, various podcast providers, other online social networks, online video game providers, etc.), that serves said digital content via an Internet website. Media content can be digital videos (e.g, videos posted on a video-sharing website such as YouTube®, etc.), digital images (e.g. digital images posted on picture sharing website such as Pinterest®, etc.), digital audio files (e.g. digital audio files posted on online audio distribution platform such as SoundCloud), etc. Sponsors (e.g. advertisers) can include entities that provide monetary payments to content providers and/or content servers in exchange for the display of advertisements, product placements, product discussions, etc.

Content servers can implement a revenue sharing model an enables the content provider to share the revenue produced by advertising on the site. For example, a video sharing website can allow the uploader of the video to share the revenue produced by advertising on the site. Sponsors may seek to provide advertisements to specific cohorts based on such metrics as demographic and/or engagement metrics. Accordingly, the revenue sharing model can vary the portion of revenue from sponsors that is provided to a content provider based on content provider demographic and/or engagement attributes. Advertisements can be assigned to specific media content.

Content servers can provide application programming interfaces (APIs) that enable process 100 to obtain information about content providers. For example, a content provider can provide process 100 his/her login information. Process 100 can then log into the content provider's content server account and download said content provider's information such as, inter alia: content provider's demographics, content provider's content engagement statistics, etc. Content engagement statistics can include view length, number of views, number of downloads, number of verified audio plays, number of ‘likes’, number of and/or length of comments, etc. In some examples, process 100 can include additional steps (not shown) for verifying the quality of content engagement statistics. For example, natural language processing algorithms can be utilized to determine that comment content is relevant to media content subject matter. Various operations can be utilized to determine a number of unique entities that ‘liked’ the media content. Step 102 can further include providing queries to a content provider for supplemental information such as additional demographic information. Demographic information can include a content provider's sex, age, ethnic background, location, hobbies, national origin, language preferences the demographic attributes of the content provider's audience (e.g. a specific group of people within the target market at which a product or the marketing message of a product may be aimed), geotagging information, etc.

In step 104, sponsor information can be obtained. Example sponsor information can include, inter alia targeted demographics digital advertisements, payment information, etc. A sponsor can indicate a specified demographic and/or engagement parameters for process 100 to associate the sponsor's advertisement. Advertisement fees can be based on said demographic and/or engagement parameters.

In view of this, in step 106 the content provider's revenue sharing rate can be calculated as a function of his/her demographic and/or engagement statistics. For example, a content provider with demographics and/or engagement statistics that match one or more sponsors specified demographic and/or engagement parameters can be calculated to have a specified value. In various embodiments, appraisals of content provider rates can be calculated on a periodic basis, upon each display of a content provider's media content, on an advertiser-by-advertiser basis, upon detected changes in a content provider's demographic and/or engagement statistics, etc.

In step 108, an electronic message e.g. an email, a text message, a push notification, a web page element, etc.) can be generated that provides the content provider the information generated in step 106. The electronic message can be displayed to the content provider on a computer display. Process 100 can store the information obtained in step 102 in a database. Process 100 can be implemented by one or more computer systems implemented in a server(s). Said server(s) can be implemented in a cloud-computing environment. Process 100 can be implement for each content server entity that a content provider wishes to utilize (e.g. one appraisal for YouTube®, one appraisal for Instagram®, one appraisal for a blog post, etc.). The equations utilized by process 100 can vary based on the content server and/or other factors Process 100 can also determine a portion of the revenue sharing model to be paid to the entity implementing process 100 to provide a content-provider appraisal It is noted that, in some embodiments, process 100 can be modified for use by content servers and/or sponsor entities to appraise the values of various content providers.

Process 100 can be utilized to provide content provider's various appraisal estimators of the value their media content (e.g, on a per view rate, a per tweet rate, etc.). For example, Paul Johnson can be a content provider that creates cooking videos. Mr. Johnson can upload his cooking videos to YouTube®. YouTube® can implement a revenue sharing model with its content providers. Mr. Johnson can be a YouTube® partner and receive revenue from views of his cooking videos on YouTube®. Mr. Johnson may want to determine his appraisal value for the cooking videos he has uploaded to YouTube®. Mr. Johnson can use process 100 to determine his appraisal value. Process 100 can log into YouTube® via an API and obtain Mr. Johnson's demographic and engagement statistics. Process 100 can obtain Mr. Johnson's demographic information from other sources as well. For example, process 100 can send electronic messages to Mr. Johnson for additional information via fillable digital forms. Process 100 can obtain demographic information (both explicit and implied) from Mr. Johnson's online social network profiles. Process 100 can determine rates generally paid for similar demographic and/or engagement statistics. Process 100 can also utilize machine learning and/or probability models (e.g. logistic regression, Bayesian prediction models, random forest models, a nearest k neighbor and/or other classification algorithms, etc.) to predict and further refine Mr. Johnson's appraisal value per YouTube's revenue sharing model. Training data sets, backtesting and ensemble methods can be used for variable selection and weighting of Mr. Johnson's demographic and engagement statistics. Accordingly, Mr. Johnson's demographic and engagement statistics can be represented as vectors (e.g. one dimensional arrays with demographic and/or engagement values as weighted elements, etc.) for implementation in computational algorithms. In this way, the demographic and engagement statistics can be quantified (e.g. a ‘like’ rate, a ‘view’ rate, etc.). Similarity metrics can be mathematically modeled from various statistics methods (e.g. a function that quantifies the similarity of two objects, cluster analysis, etc.). The appraisal value provided by process 100 can be delivered to Mr. Johnson. Mr. Johnson can utilize this appraisal value when negotiating with the content server entity or a sponsor entity. The appraisal value can also be delivered to the content server/sponsor entities as well (e.g. when a request to do so is generated by Mr. Johnson). Mr. Johnson's appraisal can be provided in the form of a range of values (e.g. an interval with endpoints about a median appraisal value generated by one or more appraisal equations/models).

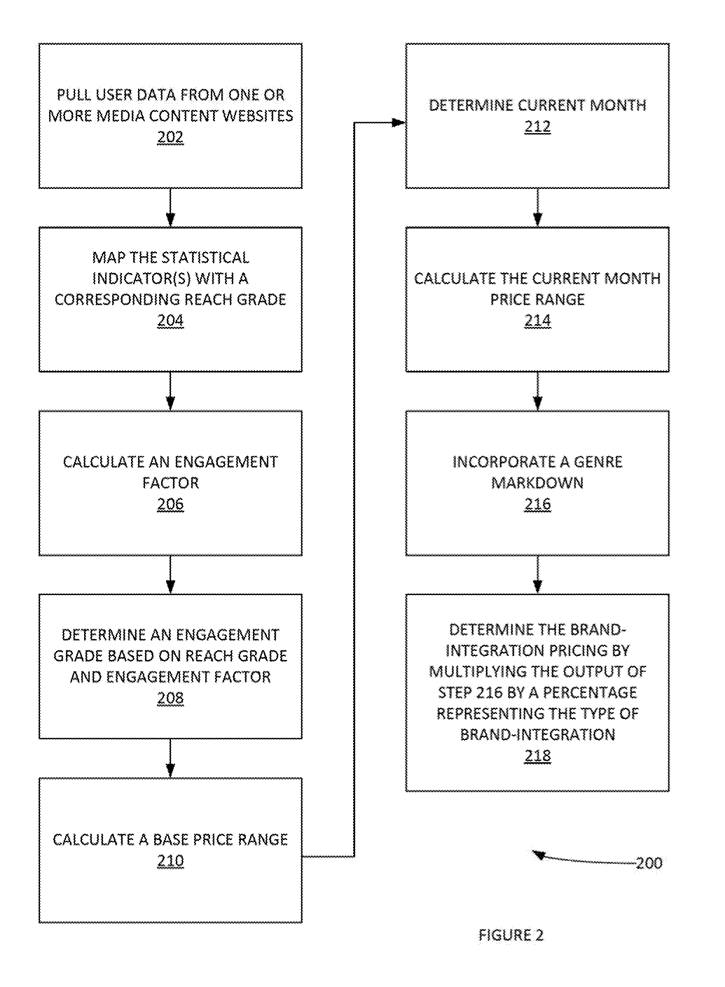

FIG. 2 illustrates an example process 200 for custom brand-integration pricing, according to some embodiments. In step 202, process 200 can user data can be pulled from one or more media content websites (e.g. a video-sharing website API, an online social networking website API, etc.). User data can be an indicator of the popularity of the user's content on the media content website. Example indicators can include, inter aria: comments information, ‘likes’ information, views information, genre information, etc. Quantitative data can be represented in various statistical measures (e.g. averages, medians, modes, etc.). In step 204, process 200 can map the statistical indicator(s) (e.g. average views) with a corresponding reach grade on a chart, index, etc. In step 206, process 200 can calculate an engagement factor In some examples, the engagement factor can be based on the following expression provided by way of example and not of limitation: Engagement Factor=(Average Comments+Average Likes)/(Average Views). In step 208, process 200 can determine an engagement grade based on the reach grade and the engagement factor In step 210, process 200 can locate the price range (e.g. in cents) based on the Reach Grade value and Engagement Grade value and calculate a base price range. In some examples, the base price range can be based on the following expression provided by way of example and not of limitation: Base Price Range=Average Views* Price Range. In step 212, process 200 can determine the current month. In step 214, process 200 can calculate the current month price range. In some examples, the current month price range can be based on the following expression provided by way of example and not of limitation: Current Month Price Range=Base Price Range*(1+% Markup). In step 216 process 200 incorporate a genre markdown (e.g into the calculation of the current month price range output). Different genres can be discounted based on various factors such as popularity of a specified genre, etc. In step 216, process 200 can apply price caps. In step 218, process 200 can determine the brand-integration pricing by multiplying the output of step 216 by a percentage representing the type of brand-integration to be integrated into the user's media-content feed. Examples of brand integration include, inter alia: custom brand integration, shout outs, product placement, direct link, activity feed, etc.

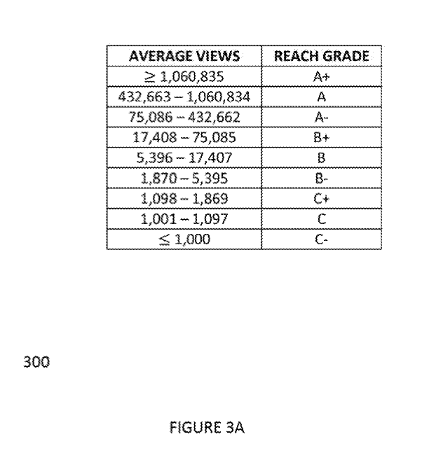

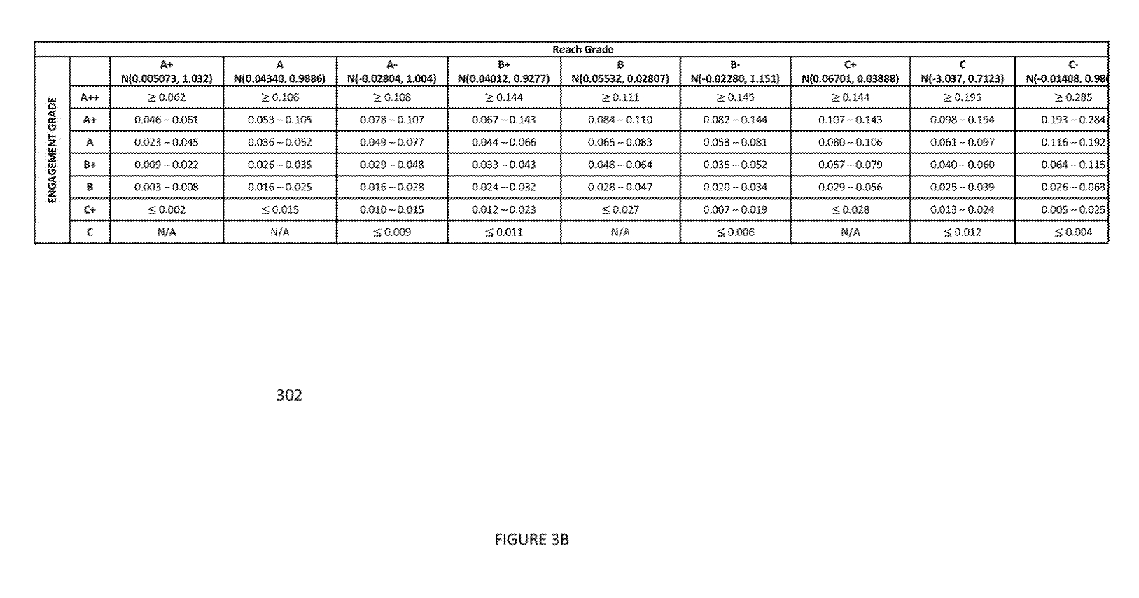

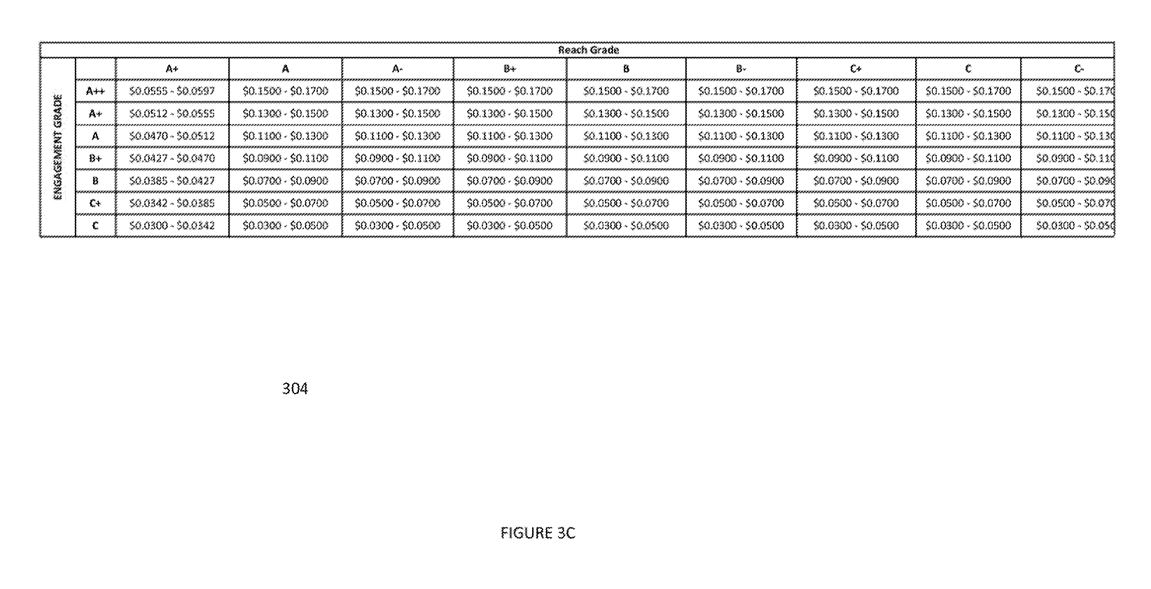

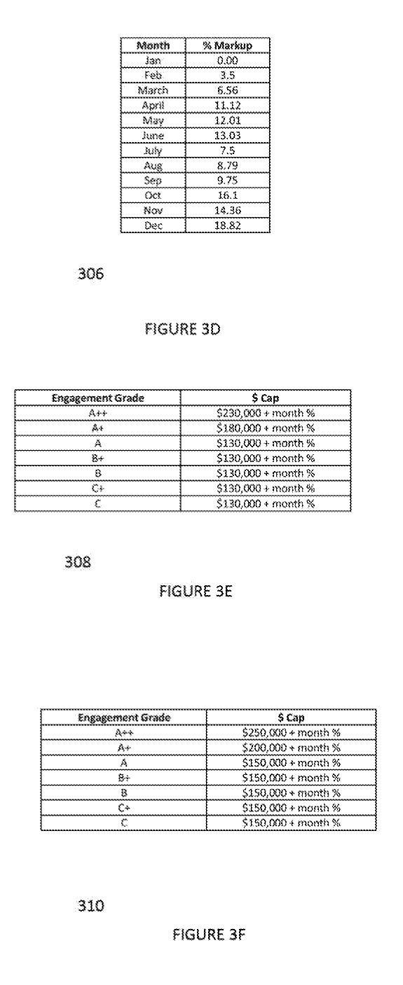

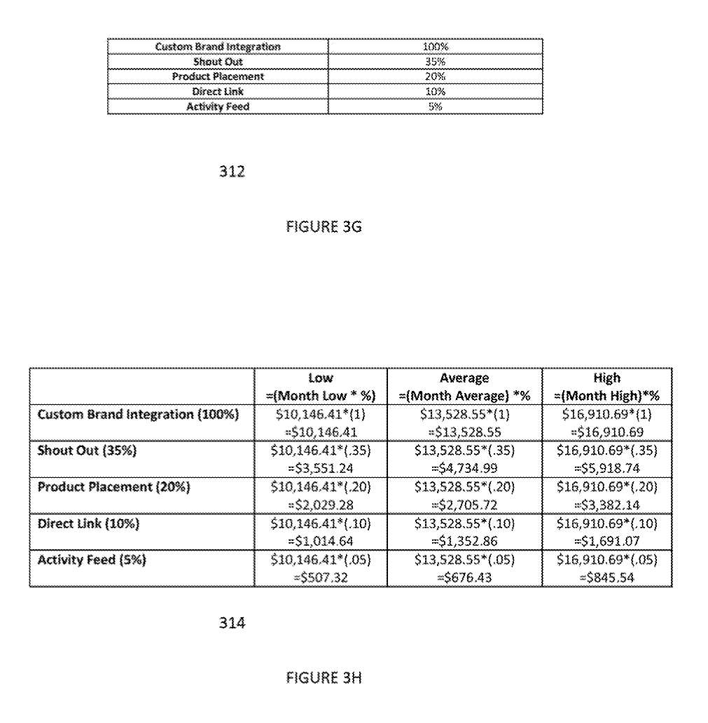

FIGS. 3 A-H illustrate example indices for implementing process for custom brand-integration pricing, according to some embodiments. More specifically, FIG. 3A illustrates an example a reach-grade index. The reach-grade index can be stored in a computer store. The reach-grade index can map an average number of a content provider's video views (e.g. a total number of video views divided by the total number of videos uploaded by the user, etc.),

FIG. 3B illustrates an example engagement-grade index. The engagement-grade index can map a calculated engagement factor to the reach grade of the content provider. FIG. 3C illustrates an example price-range index. The price-range index can map calculated engagement factor to the reach grade of the content provider.

FIG. 3D illustrates an example month index. A month index can map a current month to implement the automated custom brand-integration with a markup percentage. In this way, certain months can be discounted and other months can be modified to increase the price range. FIG. 3E illustrates an example price caps index used to set a lower price cap. FIG. 3F illustrates an example price caps index used to set a suggested price cap.

FIG. 3G illustrates an example brand-integration type price modification index. The final price range (e.g, calculated using the indices of FIGS. 3 A-F) can be multiplied by the percentages corresponding to a specified brand integration type selected by an entity wishing to advertise via a brand integration with the content provider's videos. FIG. 3H illustrates an example set of price ranges implemented using the indices of Figures A-G as based on each type of available brand integration. It is noted that in other example embodiments, other types of brand integration can be utilized.

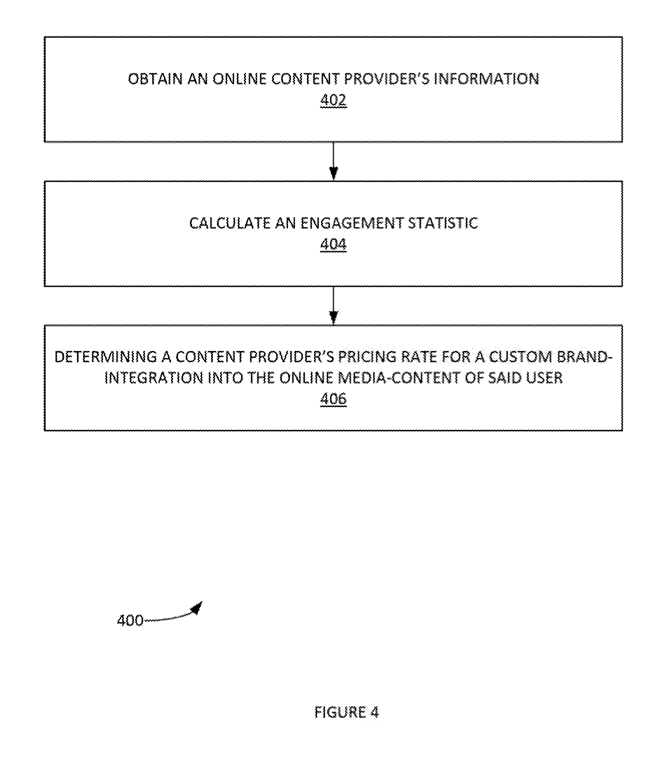

FIG. 4 illustrates an example process 400 for implementing automated custom brand integration pricing, according to some embodiments, in step 402, process 400 can implement the step of obtaining an online content provider's information, wherein an online content provider comprises a user of an online media-content sharing website that uploads media content available on said online media-content sharing website, and wherein the online content provider's information comprises a popularity indicator of the user's media content on said online media-content sharing website. In step 404, process 400 can implement the step of calculating an engagement statistic, wherein the engagement statistic is a function of the online content provider's information. In step 406, process 400 can implement the step of determining a content provider's pricing rate for a custom brand-integration into the online media-content of said user, wherein the content provider's pricing rate is a function of the engagement statistic.

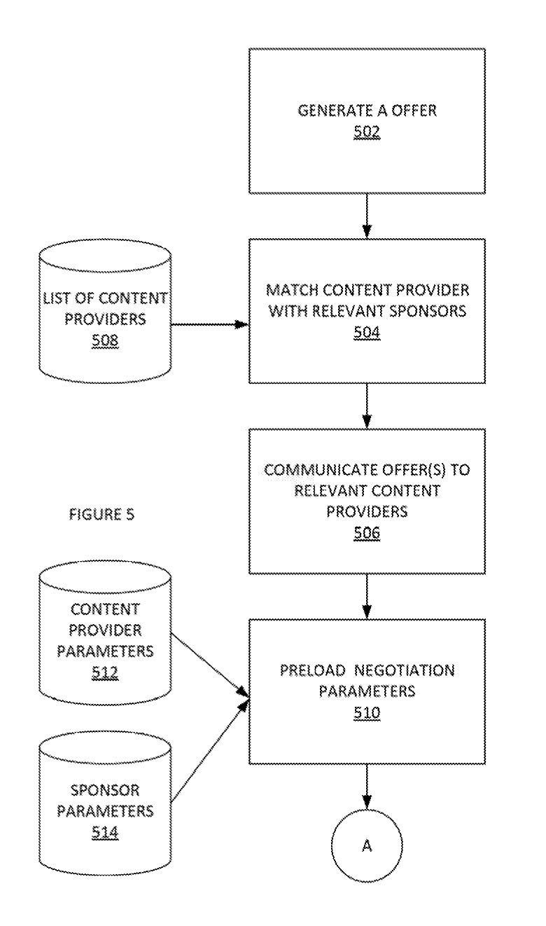

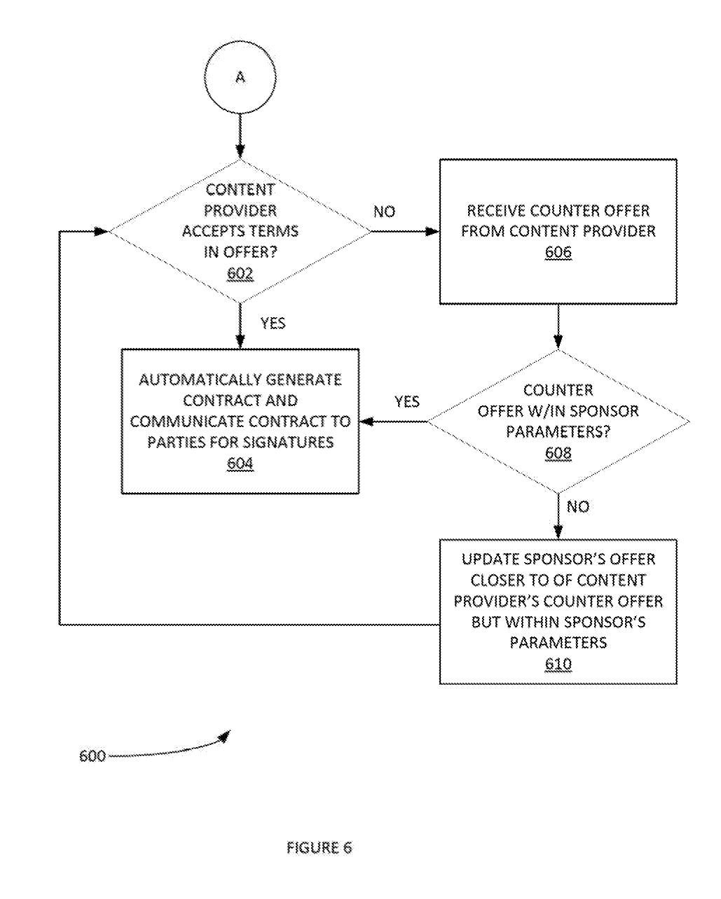

In some embodiments sponsors can make offers (e.g. can include an RfP) to content providers to promote a product, good, or service. In this way, sponsors can manage marketing plans (e.g. influencer marketing, word-of-mouth marketing, etc.) by utilizing content providers. This can be done through media content propagated through a content server's platform (e.g. via a content provider's YouTube® videos). Given the ever increasing number of content providers, sponsors can utilize the processes and/or systems provided herein to quickly form marketing contracts on the fly. Conversely, content providers can also utilize the processes and/or systems herein to form marketing contracts on a large scale. FIGS. 5 and 6 illustrates example processes 500 and 600 that can be utilized to automatically form marketing/advertisement contract between content providers, sponsors and/or content servers, according to some embodiments.

More specifically, in FIG. 5, process 500 includes step 502. In step 502, a sponsor can generate an offer. The offer can be for a marketing campaign that can be implemented by the content provider on one or more content server platforms. In step 504, the sponsor can be matched with relevant content providers. These matches can be algorithmically performed based on such factors as matches between content provider demographic and/or engagement statistics and the sponsor's target cohort, etc. Content provider information can be stored in database 508. In some examples, a sponsor can manually select content providers from a list of available sponsors. In step 506, the offer can be communicated to one or more selected content providers. In step 510, the sponsor can frontload his/her negotiation parameters and associate said parameters with the offer. For example, the content provider can provide a minimum fee to be accepted for an overlay advertisement for each view of a YouTube® video. Content provider negotiation parameters can be stored in database 512. Sponsor negotiation parameters can be stored in database 514. Content-provider negotiation parameters can be stored in database 512 and in some embodiments, content-provider negotiation parameter can also be preloaded in step 510. Returning to the previous example, a sponsor can be a cooking pot company. The company can contract with Mr. Johnson to discuss their pots on Twitter® and/or share pictures of himself cooking with their cooking pots on Instagram®. The cooking pot company may have sent Mr. Johnson a request for the contract with proposed terms.

In FIG. 6, process 600 step 602 can be used to determine if a content provider accepted the terms of the offer. If ‘yes’, then process 600 can proceed to step 604. In step 604, process 600 can automatically generate contract and communicate contract to parties for signatures. If ‘no’, then in step 606, process 600 can receive a counter offer from the content provider. In step 608, it can be determined if the counter offer is within the sponsors negotiation parameters (e.g. pre-provided s parameters 512). If ‘yes’, then process 600 can proceed to step 604. In ‘no’, then process 600 can update sponsor's offer closer to of the content provider's counter offer but within sponsor's parameters. Process 600 can then return to step 602. Process 600 can end any time a party doesn't respond with a counter offer or an acceptance. Returning to the previous example, the cooking pot company can generate a list of offers and assign the offers to one or more content providers, including Mr. Johnson. Each content provider can receive an offer. In some examples, process 500 can modify each offer based on formatting requirement and other factors associated with a particular content provider. For example, the cooking pot company can utilize process 500 to send an offer to Mr. Johnson. The cooking pot company may then go offline. While the cooking pot company is offline, Mr. Johnson can respond with a counter offer. The counter offer may be for a price per view that is lower than the cooking pot company's original offer amount but within his threshold acceptance parameters. Accordingly, process 600 can automatically accept the Mr. Johnson's counter offer. Process 600 can then generate a contract and communicate the contract to Mr. Johnson and the appropriate representative of the cooking company (e.g. the legal department) for further processing.

An online escrow system can be implemented to hold funds exchanged per the processes provided supra. Mr. Johnson can set up an escrow account with the online escrow service. YouTube® can place funds in the escrow account. When it is verified that Mr. Johnson's videos have received the requisite viewing metrics, the online escrow service can release said funds to Mr. Johnson's specified bank account.

Exemplary Environment and Architecture

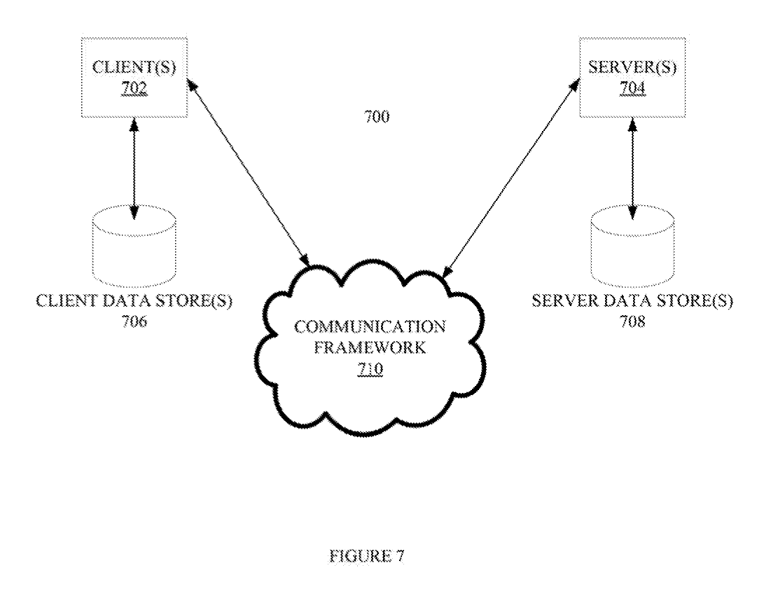

FIG. 7 is a block diagram of a sample computing environment 700 that can be utilized to implement some embodiments. The system 700 further illustrates a system that includes one or more client(s) 702. The client(s) 702 can be hardware and/or software (e.g., threads, processes, computing devices). The system 700 also includes one or more server(s) 704. The server(s) 704 can also be hardware and/or software (e.g., threads, processes, computing devices). One possible communication between a client 702 and a server 704 may be in the form of a data packet adapted to be transmitted between two or more computer processes. The system 700 includes a communication framework 710 that can be employed to facilitate communications between the client(s) 702 and the server(s) 704. The client(s) 702 are connected to one or more client data store(s) 706 that can be employed to store information local to the client(s) 702. Similarly, the server(s) 704 are connected to one or more server data store(s) 708 that can be employed to store information local to the server(s) 704.

In some embodiments, system 700 can be include and/or be utilized by the various systems and/or methods described herein to implement processes 100, 200, 400 as well as other processes. Processes 100, 200 and the indices of FIGS. 3 A-G can be stored in databases 706 and/or 708.

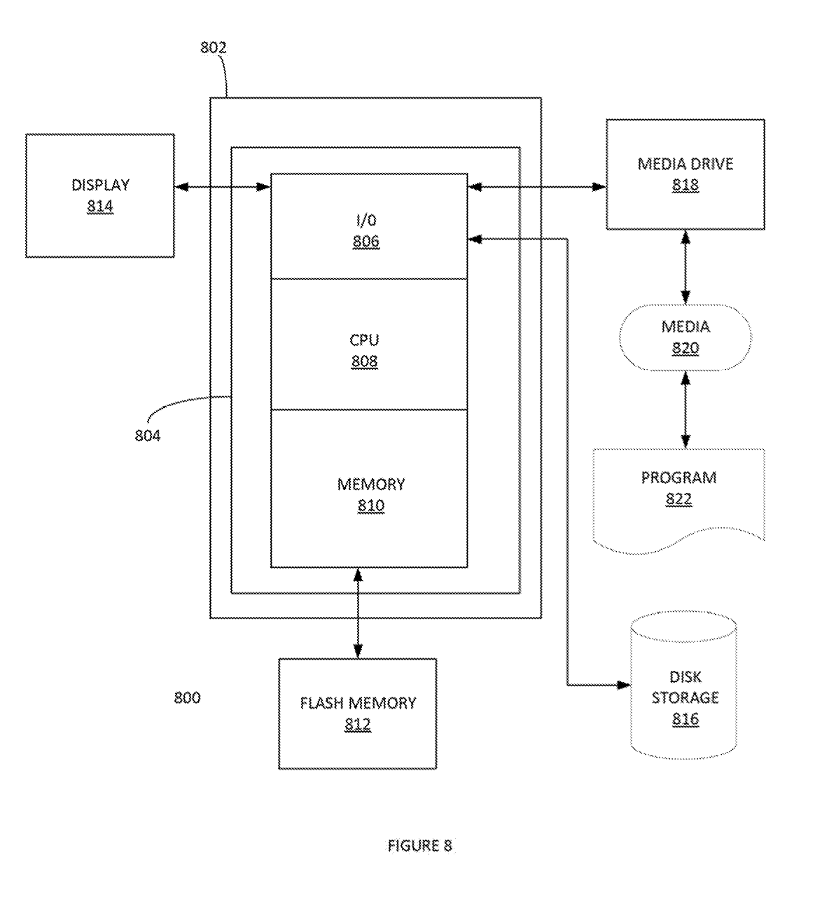

FIG. 8 depicts an exemplary computing system 800 that can be configured to perform any one of the processes provided herein. In this context, computing system 800 may include, for example, a processor, memory, storage) and I/O devices (e.g., monitor, keyboard, disk drive, Internet connection, etc.). However, computing system 800 may include circuitry or other specialized hardware for carrying out some or all aspects of the processes. In some operational settings, computing system 800 may be configured as a system that includes one or more units, each of which is configured to carry out some aspects of the processes either in software, hardware, or some combination thereof.

FIG. 8 depicts computing system 800 with a number of components that may be used to perform any of the processes described herein. The main system 802 includes a motherboard 804 having an I/O section 806, one or more central processing units (CPU) 808, and a memory section 810, which may have a flash memory card 812 related to it. The I/O section 806 can be connected to a display 814, a keyboard and/or other user input (not shown), a disk storage unit 816, and a media drive unit 818. The media drive unit 818 can read/write a computer-readable medium 820, which can contain programs 822 and/or data. Computing system 800 can include a web browser. Moreover, it is noted that computing system 800 can be configured to include additional systems in order to fulfill various functionalities. In another example, computing system 800 can be configured as a mobile device and include such systems as may be typically included in a mobile device such as GPS systems, gyroscope, accelerometers, cameras, augmented-reality systems, etc.

In one example, the systems of FIG. 8 can be utilized to implement processes the systems and processes of FIGS. 1-4. It is noted that databases described herein can be automatically sampled by the statistical algorithm. There are several methods which may be used to select a proper sample size and/or use a given sample to make statements (within a range of accuracy determined by the sample size) about a specified population. These methods may include, for example:

1. Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived.

2. Bayesian Analysis as, for example, in “Bayesian Data Analysis” by A Gelman, 1. B. Carlin, H. S. Stem and D. B. Rubin, Chapman and Hall 1995; Chapter 7, where several sampling designs are discussed.

3. Artificial Intelligence techniques, or other such techniques as Expert Systems or Neural Networks as, for example, in “Expert Systems: Principles and Programming” by Giamatano and G. Riley, PWS Publishing 1994; Chapter 4, or “Practical Neural Networks Recipes in C++” by T. Masters, Academic Press 1993; Chapters 15,16,19 and 20, where population models are developed from acquired data samples.

4. Latent Dirichlet Allocation, Journal of Machine Learning Research 3 (2003) 993-1022, by David M. Blei, Computer Science Division, University of California, Berkeley, Calif. 94720, USA, Andrew V. Ng, Computer Science Department, Stanford University, Stanford, Calif. 94305, USA

It is noted that these statistical and probabilistic methodologies are for exemplary purposes and other statistical methodologies can be utilized and/or combined in various embodiments. These statistical methodologies can be utilized in whole or in part as well.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for implementing automated custom brand-integration pricing and useful for improving online digital advertisements comprising:
obtaining an online content provider's information, wherein an online content provider comprises a user of an online media-content sharing website that uploads media content available on said online media-content sharing website, and wherein the online content provider's information comprises a popularity indicator of the user's media content on said online media-content sharing website;
calculating an engagement statistic, wherein the engagement statistic is a function of the online content provider's information;
determining a content provider's pricing rate for a custom brand-integration into the online media-content of said user wherein the content provider's pricing rate is a function of the engagement statistic.

2. The computerized method of claim 1, wherein the user's media content comprises a digital video, digital audio file or a digital image uploaded to the online media-content sharing website.

3. The computerized method of claim 2, wherein an engagement statistic comprises an aggregated value based on a video-view length value, a number of videoviews value, a number of video downloads value and a number of comments value.

4. The computerized method of claim 3 further comprising:
determining a number of unique entities that downloaded the online media-content.

5. The computerized method of claim 1, wherein the online media-content sharing website comprises an online social networking website.

6. The computerized method of claim 1, wherein the online media-content sharing website comprises an online a video-sharing website.

7. The computerized method of claim 6, wherein the custom brand-integration comprises a product placement in the digital video.

8. A computerized system useful for implementing automated custom brand-integration pricing and useful for improving online digital advertisements comprising:
(a) a computer store containing data, wherein the data comprises:
a. a set of online content provider's information from an application programming interface of an online video sharing website, wherein the set of online content provider's information comprises:
i. an average number of comments or an online content provider's uploaded videos,
ii. an average number of likes for the online content provider's uploaded videos,
iii. an average number of views for the online content provider's uploaded videos,
iv. a genre of the online content provider's uploaded videos;
b. a reach-grade index that maps an average number of view for the online content provider's uploaded videos with a reach grade;
an engagement gradeindex that maps the reach grade with an engagement factor to determine the engagement grade;
d. a price-range index that maps the engagement grade with the reach grade to determine a price range;
e. a month index that maps a current month with a base price-range percentage modification;
f. a price cap index that maps a modified price range to a price boundary; and
g. a brand-integration type price modification index that modifies the modified price range based on a brand-integration type;
(b) a computer server, which computer server is coupled to the computer store and programmed to:
a. obtain the set of online content provider's information from an application programming interface of an online video sharing website;
b. obtain the average number of views for the online content provider's uploaded videos and the reach-grade index from the computer store;
c. determine the reach grade;
d. calculate an engagement factor;
e. obtain the engagement grade index from the computer store;
f. determine the engagement grade based on the reach grade and engagement factor;
g. obtain the price-range index from the computer store;
h. determine the price range based on the reach grade and the engagement grade;
i. calculate a base price range;
j. determine a current month to implement the automated custom brand-integration;
k. obtain the month index from the computer store;
l. modify the base price range based up the current month index;
m. obtain the price cap index from the computer store;
n. apply the price caps provided in the price cap index;
o. obtain the brand-integration type price modification index from the computer store; and
p. generate a modified price range based on the type of a specified brand integration.

9. The computer system of claim 8, wherein the engagement factor is calculated as the engagement factor equals the average number of comments divide by the average number of views.

10. The computer system of claim 9, wherein the price range is determined in United States cents.

11. The computer system of claim 10, wherein the base price range is calculated using the following equation: Base Price Range=Average Views*Price Range.

12. The computer system of claim 11, wherein the final price range is modified based on the genre of the online content provider's uploaded videos.

13. The computer system of claim 12, wherein the current month index is used to modify the base price range with the equation: current month price range=base price range* (1+percent markup indicated in the current month index).

14. The computer system of claim 13, wherein the specified brand integration comprises custom bran integration, wherein the modified price range is not modified by an application of the brand integration index.
